(19) United States
(12) Patent Application Publication
(10) Pub. No.: US 2024/0230950 A1
(43) Pub. Date: Jul. 11, 2024

(54) METHOD FOR ASSOCIATING PRECIPITATION FORECAST CAPABILITY WITH TELECONNECTION EFFECT BASED ON COEFFICIENTS OF DETERMINATION

(71) Applicant: SUN YAT-SEN UNIVERSITY, Guangdong (CN)

(72) Inventors: Tongtiegang ZHAO, Guangdong (CN); Haoling CHEN, Guangdong (CN)

(73) Assignee: SUN YAT-SEN UNIVERSITY, Guangdong (CN)

(21) Appl. No.: 17/927,746

(22) PCT Filed: Oct. 13, 2021
(86) PCT No.: PCT/CN2021/123451

§ 371 Date: Apr. 20, 2023

(51) Int. Cl. G01W 1/10; G01W 1/14

(52) U.S. Cl. CPC G01W 1/10; G01W 1/14

(57) ABSTRACT

Provides a method for associating a precipitation forecast capability with a teleconnection effect based on coefficients of determination, including following steps: acquiring historical forecast precipitation data, observed precipitation data, and a climate index sample sequence, and obtaining original sample data; establishing regression equations of observed precipitation and forecast precipitation, observed precipitation and a climate index, and observed precipitation and a union set of the forecast precipitation and the climate index, and calculating corresponding coefficients of determination through the regression equations; calculating variances explained by the forecast precipitation alone, by the climate index alone, and by the forecast precipitation and the climate index alone; processing the variances by means of bootstrapping to obtain a reference distribution of the variances; and comparing the original sample data with the reference distribution of the variances to obtain an association result of the precipitation forecast capability and the teleconnection effect.

### TECHNICAL FIELD

The present invention relates to the technical field of precipitation forecasting, in particular to a method for associating a precipitation forecast capability with a teleconnection effect based on the coefficient of determination.

### RELATED ART

Accurate seasonal precipitation forecast has important value and broad application prospects in the fields of disaster prevention and mitigation of natural disasters such as floods and droughts, and in the fields of water resources planning and management, etc. El Niño-Southern Oscillation (ENSO) is an important driving factor of global seasonal precipitation anomalies. In some studies, climate modes characterizing ENSO events is used as predictors and seasonal precipitation is predicted by means of teleconnection effects of climate modes (such as Niño3.4, Niño3 and Niño4). In addition, meteorological and climate centers in many countries and regions in the world have begun to research and develop their own global climate models (GCMs). These models characterize various key physical processes related to climate, and their forecast results have clear physical meanings.

Although climate modes and GCM precipitation forecast can provide information for seasonal precipitation, when it comes to practical application of these information, it is difficult to judge whether GCM seasonal precipitation with a certain physical meaning includes information of key teleconnection effects; and it is difficult to judge that in different regions of the world to what extent information provided respectively by the climate modes and the GCM seasonal precipitation is redundant, and that how much information is respectively provided by the climate modes and the GCM seasonal precipitation. In order to answer these questions, it is necessary to provide a simple and practical method to judge the overlap and difference between the information of the climate modes and the GCM seasonal precipitation, so as to provide a certain reference for the use of forecast information in practical services.

### SUMMARY OF INVENTION

### Technical Problem

In order to solve the problem in judging the overlap and difference between information of global climate model based seasonal precipitation forecast and key teleconnection effects, the present invention provides a method for associating a precipitation forecast capability with a teleconnection effect based on coefficients of determination.

### Solution to Problem

In order to solve the above technical problem, the present invention adopts the following technical solution:

A method for associating a precipitation forecast capability with a teleconnection effect based on coefficients of determination, including following steps:
S1: acquiring historical forecast precipitation data, observed precipitation data, and a climate index sample sequence, and obtaining original sample data;
S2: establishing a regression equation of observed precipitation and forecast precipitation, a regression equation of observed precipitation and a climate index, and a regression equation of observed precipitation and a union set of the forecast precipitation and the climate index, and respectively calculating corresponding coefficients of determination through the regression equations;
S3: according to the coefficients of determination, respectively calculating a variance explained by the forecast precipitation alone, a variance explained by the climate index alone, and a variance repeatedly explained by the forecast precipitation and the climate index alone based on set operation;
S4: processing the variances by means of bootstrapping to obtain a reference distribution of the three variances; and
S5: comparing the original sample data with the reference distribution of the three variances to obtain an association result of the precipitation forecast capability and the teleconnection effect.

### Effects of Invention

Compared with the prior art, the technical solution of the present invention has the following beneficial effects: the present invention combines the set operation with the coefficients of determination in linear regression, and simply and effectively distinguishes overlapped and different components in observed precipitation information provided by the precipitation forecast and the climate modes, thereby providing a reference for the use of a service of the precipitation forecast.

### BRIEF DESCRIPTION OF DRAWINGS

FIG. 1 is a flowchart of a method for associating a precipitation forecast capability with a teleconnection effect based on coefficients of determination according to Embodiment 1.

FIG. 2 is a distribution diagram of correlation coefficients of an index Niño3.4 and observed precipitation in December, January, and February (DJF).

FIG. 3 is a spatial distribution diagram of coefficients of determination.

FIG. 4 is a spatial distribution diagram of independent and overlapped components in information provided by forecast precipitation and Niño3.4.

FIG. 5 is a distribution diagram of association relationship classification conditions of information of forecast precipitation and Niño3.4 on a global grid.

FIG. 6 is a Venn diagram of information of forecast precipitation and Niño3.4 under eight different association relationship classification conditions.

### DESCRIPTION OF EMBODIMENTS

The accompanying drawings are merely used for exemplary description, and should not be construed as a limitation to the present patent.

For those skilled in the art, it is understandable that some well-known structures in the accompanying drawings and their descriptions may be omitted.

The technical solution of the present invention is further described below with reference to the accompanying drawings and the embodiments.

### Embodiment 1

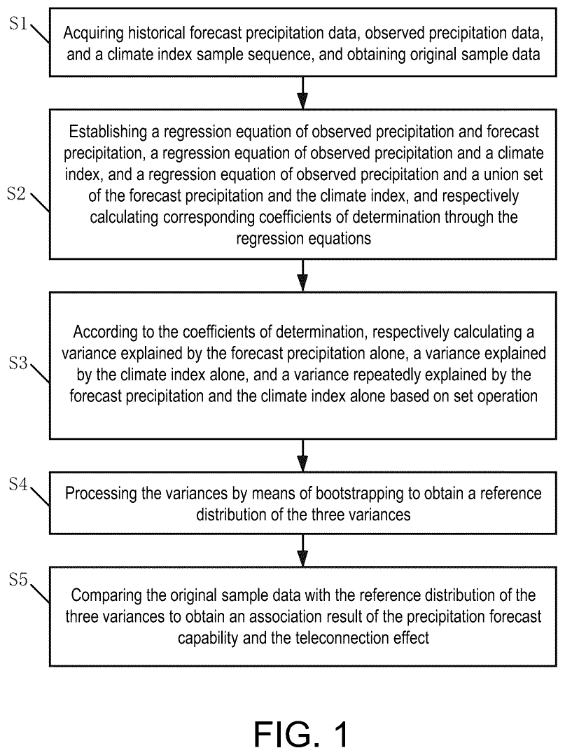

The present embodiment provides a method for associating a precipitation forecast capability with a teleconnection effect based on coefficients of determination. FIG. 1 shows a flowchart of the method for associating a precipitation forecast capability with a teleconnection effect based on the coefficients of determination in the present embodiment.

The method for associating the precipitation forecast capability with the teleconnection effect based on the coefficients of determination provided by the present embodiment includes the following steps:
S1: historical forecast precipitation data, observed precipitation data, and a climate index sample sequence are acquired, and original sample data is obtained.

A climate index contained in the climate index sample sequence includes niño3.4, niño3 and/or niño4. In the present embodiment, the niño3.4 is selected and used as the climate index.
S2: a regression equation of observed precipitation and forecast precipitation, a regression equation of observed precipitation and a climate index, and a regression equation of observed precipitation and a union set of the forecast precipitation and the climate index are established, and corresponding coefficients of determination are respectively calculated through the regression equations.

In this step, the regression equation of the observed precipitation oₖ and the forecast precipitation fₖ, the regression equation of the observed precipitation oₖ and the climate index niño3.4ₖ, and the regression equation of the observed precipitation oₖ and the union set (f∪niño3.4) of the forecast precipitation and the climate index are respectively established, and the coefficients of determination determined by the above three regression equations are further calculated.

A calculation formula for a coefficient of determination R²(o˜f) determined by the regression equation of the observed precipitation oₖ and the forecast precipitation fₖ is as follows:

$${o}_{k} = {α}_{1} + {β}_{1} {f}_{k} + {ε}_{1 , k} {R}^{2} ( o \sim f ) = 1 - \frac{{\sum }_{k} {ε}_{1 , k}^{2}}{{\sum }_{k} {( {o}_{k} - \overline{o} )}^{2}} \\ \overline{o} = \frac{1}{K} {\sum }_{K}^{k = 1} {o}_{k} , k = 1 , 2 , … , K$$

where oₖ represents observed precipitation data in the k-th year, fₖ represents forecast precipitation data in the k-th year, and K is the total number of years of precipitation data; α₁ and β₁ are an intercept term and a slope term of a linear regression model; ε_{1,k} is a residual term of the linear regression model; and ō represents an average annual value of observed precipitation. The corresponding coefficients of determination can be calculated by comparing a residual sum of squares and a total variance of observed precipitation.

A calculation formula for a coefficient of determination R²(o˜niño3.4) determined by the regression equation of the observed precipitation oₖ and the climate index niño3.4ₖ is as follows:

$${o}_{k} = {α}_{2} + {β}_{2} ni \tilde{n} o {3.4}_{k} + {ε}_{2 , k} {R}^{2} ( o \sim ni \tilde{n} o 3.4 ) = 1 - \frac{{\sum }_{k} {ε}_{2 , k}^{2}}{{\sum }_{k} {( {o}_{k} - \overline{o} )}^{2}}$$

where niño3.4ₖ is the climate index niño3.4 sample sequence in the k-th year, α₂ and β₂ are the intercept term and slope term of the linear regression model; and ε_{2,k} is the residual term of the linear regression model.

A calculation formula for a coefficient of determination R²(o˜f∪niño3.4) determined by the regression equation of the observed precipitation oₖ and the union set (f∪niño3.4) of the forecast precipitation and the climate index is as follows:

$${o}_{k} = {α}_{3} + {β}_{3 , 1} {f}_{k} + {β}_{3 , 2} ni \tilde{n} o {3.4}_{k} + {ε}_{3 , k} {R}^{2} ( o \sim f ⋃ ni \tilde{n} o 3.4 ) = 1 - \frac{{\sum }_{k} {ε}_{3 , k}^{2}}{{\sum }_{k} {( {o}_{k} - \overline{o} )}^{2}}$$

where α₃ is the intercept term of the linear regression model, and β_{3,1} and β_{3,2} are the slope terms of the linear regression model. The corresponding coefficients of determination can be calculated by comparing the residual sum of squares and the total variance of observed precipitation.
S3: according to the coefficients of determination, a variance explained by the forecast precipitation alone, a variance explained by the climate index alone, and a variance repeatedly explained by the forecast precipitation and the climate index alone are respectively calculated based on set operation.

An expression formula for the variance explained by the forecast precipitation alone is as follows:

$${R}^{2} ( o \sim f / ni \tilde{n} o 3.4 ) = {R}^{2} ( o \sim f ⋃ ni \tilde{n} o 3.4 ) - {R}^{2} ( o \sim ni \tilde{n} o 3.4 )$$

An expression formula for the variance explained by the climate index alone is as follows:

$${R}^{2} ( o \sim ni \tilde{n} o 3.4 / f ) = {R}^{2} ( o \sim f ⋃ ni \tilde{n} o 3.4 ) - {R}^{2} ( o \sim f )$$

An expression formula for the variance repeatedly explained by the forecast precipitation and the climate index alone is as follows:

$${R}^{2} ( o \sim f ⋂ ni \tilde{n} o 3.4 ) = {R}^{2} ( o \sim f ) + {R}^{2} ( o \sim ni \tilde{n} o 3.4 ) - {R}^{2} ( o \sim f ⋃ ni \tilde{n} o 3.4 ) .$$

S4: the variances are processed by means of bootstrapping to obtain a reference distribution of the three variances.

In the present embodiment, the step of processing the variances by means of bootstrapping includes: the historical forecast precipitation data and the climate index sample sequence are disrupted, the steps S2 to S3 are repeated to obtain the corresponding three variances, and until the preset number of iterations is reached, the reference distribution of the three variances is obtained.

In the present embodiment, the set number of iterations is 1,000.
S5: the original sample data is compared with the reference distribution of the three variances to obtain an association result of the precipitation forecast capability and the teleconnection effect.

In the present step, the original sample data is compared with the reference distribution of the three variances by means of a one-sided test. The step of comparing the original sample data with the reference distribution of the three variances includes: a significance level is selected, where 0.1, 0.05, and 0.01 may be selected to be the significance levels in general, and reference distribution thresholds corresponding to the significance levels are respectively 90th, 95th, and 99th percentiles of the reference distribution; when the significance level is set to be 0.1, if a value of the original sample data is greater than the 90th percentile of the reference distribution of its corresponding variances, it identifies that the value of the original sample data is significant, otherwise it identifies that the value of the original sample data is non-significant. And then a significance result is output as the association result of the precipitation forecast capability and the teleconnection effect.

In a specific implementation process, there are 8 significant results, which are specifically as shown in Table 1 below.

TABLE 1
Association relationships represented by eight different combinations

| R² | R² | R² | Classification |
|---|---|---|---|
| (o ~ f/niño3.4) | (o ~ niño3.4/f) | (o ~ f ∩ niño3.4) | meaning |
| 0 | 0 | 0 | Both forecast precipitation and |
| | | | index Niño3.4 cannot provide |
| | | | information of observed |
| | | | precipitation |
| 0 | 0 | 1 | Index Niño3.4 can, but forecast |
| | | | cannot provide information of |
| | | | observed precipitation |
| 0 | 1 | 0 | Overlapped information of |
| | | | forecast precipitation and |
| | | | Niño3.4 can provide |
| | | | information of observation and |
| | | | forecast |
| 0 | 1 | 1 | Index Niño3.4 can provide |
| | | | information of observed |
| | | | precipitation, and its |
| | | | information is partially |
| | | | overlapped with forecast |
| | | | precipitation |
| 1 | 0 | 0 | Forecast precipitation can |
| | | | provide information of |
| | | | observed precipitation, but |
| | | | Niño3.4 cannot provide related |
| | | | information |
| 1 | 0 | 1 | Both forecast precipitation and |
| | | | Index Niño3.4 can provide |
| | | | information of observed |
| | | | precipitation, and their |
| | | | information is not overlapped |
| 1 | 1 | 0 | Forecast precipitation can |
| | | | provide information of |
| | | | observed precipitation, and its |
| | | | information is partially |
| | | | overlapped with Niño3.4 |
| 1 | 1 | 1 | Both forecast precipitation and |
| | | | Niño3.4 can provide |
| | | | information of observation and |
| | | | forecast, and are overlapped |

1 represents that the value of the original sample data is identified to be significant at the corresponding coefficient of determination, and 0 represents that the value of the original sample data is identified to be non-significant at the corresponding coefficient of determination.

In the present embodiment, the set operation is combined with the coefficients of determination in linear regression, and are further combined with the bootstrapping and the one-sided test, so as to simply and effectively distinguish overlapped and different components in observed precipitation information provided by the precipitation forecast and the climate mode, thereby providing a reference for the use of a service of the precipitation forecast.

### Embodiment 2

In the present embodiment, a test is performed based on the method for associating a precipitation forecast capability with a teleconnection effect provided by the embodiment 1.

1982-2010 global seasonal grid precipitation data of the United States Climate Prediction Center (CPC) is used as observed data, a climate forecast system Version 2 (CFSv2) of the United States National Centers for Environmental Prediction (NCEP) is used as forecast precipitation data, and an index Niño3.4 is used to represent El Niño-Southern Oscillation (ENSO). CFSv2 forecast precipitation adopts seasonal forecast precipitation with a forecast period of 0 month. The winter December-January-February (DJF) is taken as an example. A spatial resolution of both observed precipitation and forecast precipitation is 1°×1°.

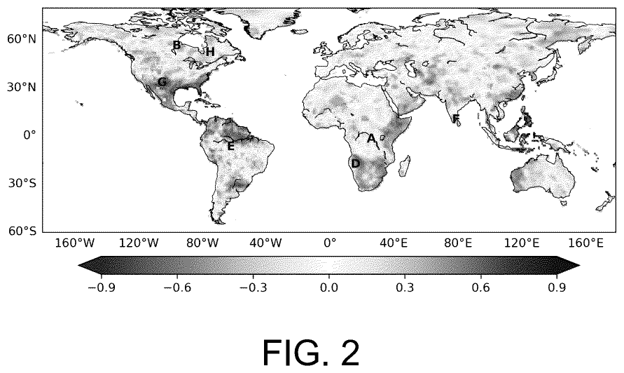

FIG. 2 shows a distribution diagram of correlation coefficients of an index Niño3.4 and observed precipitation in DJF. It can be seen from the figure that there are obvious teleconnection effects in many regions around the world, but such effects are very different in different regions and show obvious spatial correlation. For example, in southern North America, the index Niño3.4 is positively correlated with precipitation in the region, which indicates that the region has more precipitation in El Niño years and less precipitation in La Nina years. In contrast, in northern South America, the index Niño3.4 is negatively correlated with precipitation in the region, which indicates that the climate is dry in El Niño years and wet in La Nina years.

For precipitation of each grid in FIG. 2, a regression equation of observed precipitation and forecast precipitation, a regression equation of observed precipitation and the index Niño3.4, and a regression equation of observed precipitation and a union set of the forecast precipitation and the index Niño3.4 are respectively established, and corresponding coefficients of determination R²(o˜f), R²(o˜niño3.4), and R²(o˜f∪niño3.4) are respectively calculated.

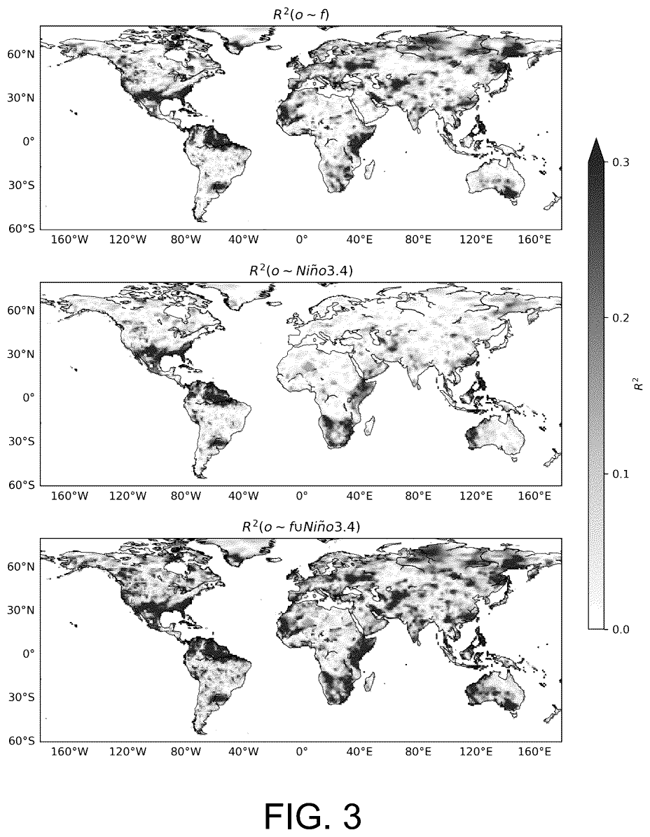

FIG. 3 shows respective global distributions of three coefficients of determination R²(o˜f), R²(o˜niño3.4), and R²(o˜f∪niño3.4). It can be seen from the figure that in some regions, such as southern North America, northern South America, and eastern Africa, etc., information provided by forecast is equivalent in size and similar in spatial distribution to information provided by Niño3.4, such that there may be a certain overlap. In addition, forecasts of some regions, such as northern Europe, northern Asia, southeastern Australia, etc., can provide more information. There are also some regions, such as western Australia, where Niño 3.4 that can provide more information. As a whole, when the union set of the forecast precipitation and the index Niño 3.4 is used as an explanatory variable, the most information (i.e., the last row of subgraphs in FIG. 3) can be explained.

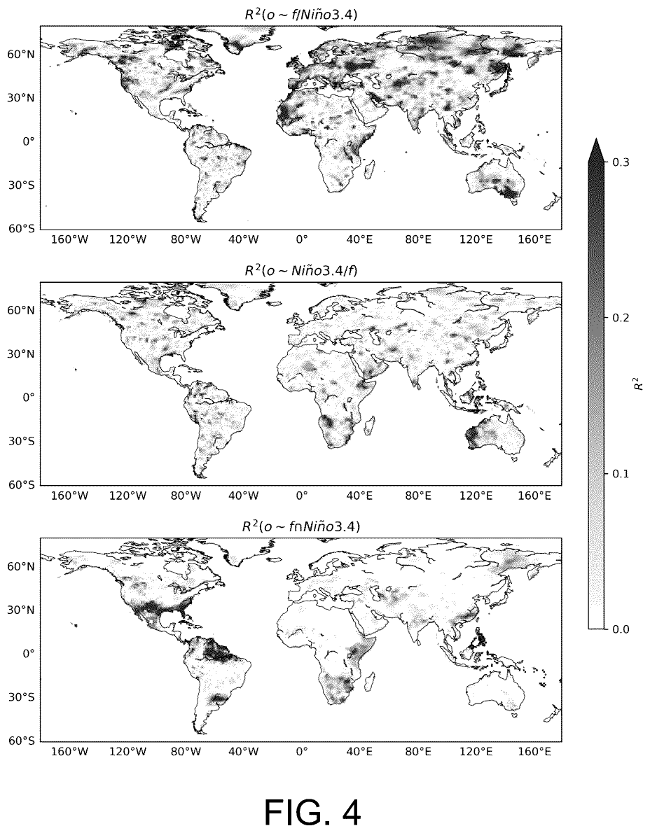

In order to quantify information respectively provided by the forecast precipitation and the Niño3.4 and overlapped information of the forecast precipitation and the Niño3.4, further, overlapped R² of the forecast precipitation and the Niño3.4 and the respectively independent R² of the forecast precipitation and the Niño3.4 are obtained by means of set operation. FIG. 4 shows a result of the set operation, that is, a spatial distribution of three variances R²(o˜f/niño3.4), R²(o˜niño3.4/f), and R²(o˜f∩niño3.4). A distribution diagram shown in FIG. 4 well distinguishes a part of the variance explained by the forecast precipitation alone, mainly positioned in some regions of northern Eurasia, southeastern Australia, western Africa, and eastern Africa. Information provided by the index Niño3.4 alone is mainly distributed in some regions of western Australia and southern Africa. Finally, the overlapped regions of the forecast precipitation and the Niño3.4 are mainly distributed in some regions of southern North America, northern South America, southeastern South America, eastern and southern Africa, and East Asia. A graphical result well confirms an expectation of FIG. 3, and it indicates that the method for associating a precipitation forecast capability with a teleconnection effect provided by the present invention can effectively distinguish information respectively provided by the forecast capability and the index Niño3.4.

Further, in the present embodiment, three groups of variances R²(o˜f/niño3.4), R²(o˜niño3.4/f), and R²(o˜f∩niño3.4) determined according to coefficients of determination are respectively subjected to a significance test. There may be eight different combinations for three groups of significance results, specifically as shown in Table 1.

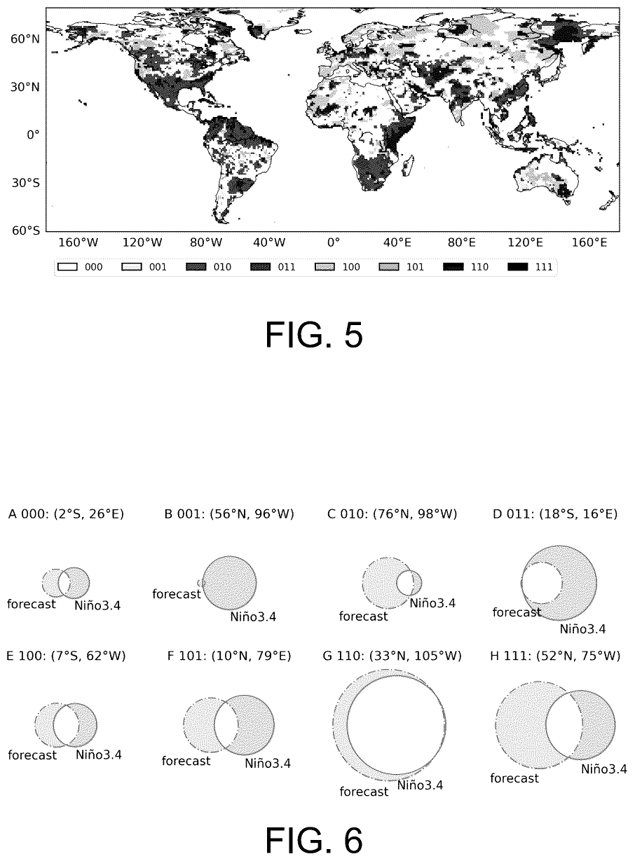

FIG. 5 is a distribution diagram of association relationship classification conditions of information of forecast precipitation and Niño3.4 on a global grid, which shows a spatial distribution of eight different conditions. Three-digit numbers in a graphic example respectively correspond to the significance results given in Table 1, where the value 1 indicates the case of significance and the value 0 indicates the case of non-significance. The first-digit number represents the significance of R²(o˜f/niño3.4), the second-digit number represents the significance of R²(o˜f∩niño3.4), and the third-digit number is the significance of R²(o˜niño3.4/f). The distribution diagram gives the difference and overlap between the information respectively provided by the final CFSv2 forecast precipitation and the index Niño3.4. For example, a grid “010”, that is to say, both the forecast precipitation and the index Niño3.4 provide information of observed precipitation, and their information is overlapped. Such grid is mainly distributed in some regions of southern North America, northern South America, southeastern South America, eastern and southern Africa, and East Asia.

Further, as shown in FIG. 6, the difference and overlap between the information are represented by a Venn diagram. From each of the obtained eight classification conditions, a grid is randomly selected (the grid position is marked with capital letters in the distribution diagram of FIG. 2), and information provided by forecast precipitation and Niño 3.4 of each grid is represented with the Venn diagram. In the figure, a yellow dashed circle represents R² of the forecast precipitation, that is, R²(o˜f), a gray solid circle represents R² of the index Niño3.4, that is, R²(o˜niño3.4), a white part where the forecast precipitation and the index Niño3.4 are overlapped is R²(o˜f∩niño3.4), parts where the forecast precipitation and the index Niño3.4 are not overlapped are respectively R²(o˜f/niño3.4) and R²(o˜niño3.4/j), and a total area of the three parts is R²(o˜f∪niño3.4). The Venn diagram shown in FIG. 6 well represents a relationship between the information, such as a D grid (011), and the information provided by the forecast capability is almost completely contained by the information provided by the index Niño3.4, which indicates that on this grid, the index Niño3.4 can provide more information, and the forecast capability does not provide information other than teleconnection. G grid (110) is to the contrary, and the information from the index Niño 3.4 is completely contained in the information provided by the forecast.

The above experimental results show that the method for associating a precipitation forecast capability with a teleconnection effect based on coefficients of determination provided by the present invention can effectively quantify the difference and overlap between the information provided by the forecast precipitation and the index Niño3.4, and can intuitively show different association relationship classification conditions, thereby providing a reference for the use of a service of the forecast.

Apparently, the above-mentioned embodiments of the present invention are only examples for clearly illustrating the present invention, and are not intended to limit the implementation modes of the present invention. Those of ordinary skill in the art may also make other changes or modifications in different forms on the basis of the above description. All implementation modes do not need to and cannot be exhausted here. Any modifications, equivalent substitutions, and improvements made within the spirit and principle of the present invention should be included within the scope of protection of the claims of the present invention.

1. A method for associating a precipitation forecast capability with a teleconnection effect based on coefficients of determination, comprising following steps:
S1: acquiring historical forecast precipitation data, observed precipitation data, and a climate index sample sequence, and obtaining original sample data;
S2: establishing a regression equation of observed precipitation and forecast precipitation, a regression equation of observed precipitation and a climate index, and a regression equation of observed precipitation and a union set of the forecast precipitation and the climate index, and respectively calculating corresponding coefficients of determination through the regression equations;
S3: according to the coefficients of determination, respectively calculating a variance explained by the forecast precipitation alone, a variance explained by the climate index alone, and a variance repeatedly explained by the forecast precipitation and the climate index alone based on set operation;
S4: processing three variances by means of bootstrapping to obtain a reference distribution of the three variances; and
S5: comparing the original sample data with the reference distribution of the three variances to obtain an association result of the precipitation forecast capability and the teleconnection effect,
wherein the three variances in the step S4 and S5 are the variance explained by the forecast precipitation alone, the variance explained by the climate index alone, and the variance repeatedly explained by the forecast precipitation and the climate index alone based on set operation.

2. The method for associating the precipitation forecast capability with the teleconnection effect based on coefficients of determination according to claim 1, wherein the climate index contained in the climate index sample sequence comprises niño3.4, niño3 and/or niño4.

3. The method for associating the precipitation forecast capability with the teleconnection effect based on coefficients of determination according to claim 2, wherein a calculation formula for a coefficient of determination R²(o˜f) determined by the regression equation of the observed precipitation and the forecast precipitation is as follows:
$${o}_{k} = {α}_{1} + {β}_{1} {f}_{k} + {ε}_{1 , k} {R}^{2} ( o \sim f ) = 1 - \frac{{\sum }_{k} {ε}_{1 , k}^{2}}{{\sum }_{k} {( {o}_{k} - \overline{o} )}^{2}} \\ \overline{o} = \frac{1}{K} {\sum }_{K}^{k = 1} {o}_{k} , k = 1 , 2 , … , K$$
wherein oₖ represents observed precipitation data in a k-th year, fₖ represents forecast precipitation data in a k-th year, and K is a total number of years of precipitation data; α₁ and β₁ are an intercept term and a slope term of a linear regression model; ε_{1,k} is a residual term of the linear regression model; and ō represents an average annual value of observed precipitation.

4. The method for associating the precipitation forecast capability with the teleconnection effect based on coefficients of determination according to claim 3, wherein a calculation formula for a coefficient of determination R²(o˜niño) determined by the regression equation of the observed precipitation and the climate index is as follows:
$${o}_{k} = {α}_{2} + {β}_{2} ni \tilde{n} {o}_{k} + {ε}_{2 , k} {R}^{2} ( o \sim ni \tilde{n} o ) = 1 - \frac{{\sum }_{k} {ε}_{2 , k}^{2}}{{\sum }_{k} {( {o}_{k} - \overline{o} )}^{2}}$$
wherein niñoₖ is the climate index in the k-th year, α₂ and β₂ are the intercept term and slope term of the linear regression model; and ε_{2,k} is the residual term of the linear regression model.

5. The method for associating the precipitation forecast capability with the teleconnection effect based on coefficients of determination according to claim 4, wherein a calculation formula for a coefficient of determination R²(o˜f∪niño) determined by the regression equation of the observed precipitation and the union set of the forecast precipitation and the climate index is as follows:
$${o}_{k} = {α}_{3} + {β}_{3 , 1} {f}_{k} + {β}_{3 , 2} ni \tilde{n} {o}_{k} + {ε}_{3 , k} {R}^{2} ( o \sim f ⋃ ni \tilde{n} o ) = 1 - \frac{{\sum }_{k} {ε}_{3 , k}^{2}}{{\sum }_{k} {( {o}_{k} - \overline{o} )}^{2}}$$
wherein α₃ is the intercept term of the linear regression model, and β_{3,1} and β_{3,2} are the slope terms of the linear regression model.

6. The method for associating the precipitation forecast capability with the teleconnection effect based on coefficients of determination according to claim 5, wherein in the step S3, an expression formula for the variance explained by the forecast precipitation alone is as follows:
$${R}^{2} ( o \sim f / ni \tilde{n} o ) = {R}^{2} ( o \sim f ⋃ ni \tilde{n} o ) - {R}^{2} ( o \sim ni \tilde{n} o )$$
an expression formula for the variance explained by the climate index alone is as follows:
$${R}^{2} ( o \sim ni \tilde{n} o / f ) = {R}^{2} ( o \sim f ⋃ ni \tilde{n} o ) - {R}^{2} ( o \sim f )$$
an expression formula for the variance repeatedly explained by the forecast precipitation and the climate index alone is as follows:
$${R}^{2} ( o \sim f ⋂ ni \tilde{n} o ) = {R}^{2} ( o \sim f ) + {R}^{2} ( o \sim ni \tilde{n} o ) - {R}^{2} ( o \sim f ⋃ ni \tilde{n} o ) .$$

7. The method for associating the precipitation forecast capability with the teleconnection effect based on coefficients of determination according to claim 1, wherein the step of processing the three variances by means of bootstrapping comprises: disrupting the historical forecast precipitation data and the climate index sample sequence, repeating the steps S2 to S3 to obtain the corresponding three variances, and until a preset number of iterations is reached, obtaining the reference distribution of the three variances.

8. The method for associating the precipitation forecast capability with the teleconnection effect based on coefficients of determination according to claim 7, wherein in the step S5, the original sample data is compared with the reference distribution of the three variances by means of a one-sided test.

9. The method for associating the precipitation forecast capability with the teleconnection effect based on coefficients of determination according to claim 8, wherein in the step S5, comparing the original sample data with the reference distribution of the three variances comprises: selecting a significance level, and determining a reference distribution threshold according to the selected significance level; if a value of the original sample data is greater than the reference distribution threshold of corresponding variances of the value of the original sample data, identifying that the value of the original sample data is significant, otherwise identifying that the value of the original sample data is non-significant; and then outputting a significance result as the association result of the precipitation forecast capability and the teleconnection effect.

10. The method for associating the precipitation forecast capability with the teleconnection effect based on coefficients of determination according to claim 9, further comprising following step: showing the significance result obtained by comparing the original sample data with the reference distribution of the three variances through a chart.

11. The method for associating the precipitation forecast capability with the teleconnection effect based on coefficients of determination according to claim 2, wherein the step of processing the three variances by means of bootstrapping comprises: disrupting the historical forecast precipitation data and the climate index sample sequence, repeating the steps S2 to S3 to obtain the corresponding three variances, and until a preset number of iterations is reached, obtaining the reference distribution of the three variances.

12. The method for associating the precipitation forecast capability with the teleconnection effect based on coefficients of determination according to claim 11, wherein in the step S5, the original sample data is compared with the reference distribution of the three variances by means of a one-sided test.

13. The method for associating the precipitation forecast capability with the teleconnection effect based on coefficients of determination according to claim 12, wherein in the step S5, comparing the original sample data with the reference distribution of the three variances comprises: selecting a significance level, and determining a reference distribution threshold according to the selected significance level; if a value of the original sample data is greater than the reference distribution threshold of corresponding variances of the value of the original sample data, identifying that the value of the original sample data is significant, otherwise identifying that the value of the original sample data is non-significant; and then outputting a significance result as the association result of the precipitation forecast capability and the teleconnection effect.

14. The method for associating the precipitation forecast capability with the teleconnection effect based on coefficients of determination according to claim 13, further comprising following step: showing the significance result obtained by comparing the original sample data with the reference distribution of the three variances through a chart.

15. The method for associating the precipitation forecast capability with the teleconnection effect based on coefficients of determination according to claim 3, wherein the step of processing the three variances by means of bootstrapping comprises: disrupting the historical forecast precipitation data and the climate index sample sequence, repeating the steps S2 to S3 to obtain the corresponding three variances, and until a preset number of iterations is reached, obtaining the reference distribution of the three variances.

16. The method for associating the precipitation forecast capability with the teleconnection effect based on coefficients of determination according to claim 15, wherein in the step S5, the original sample data is compared with the reference distribution of the three variances by means of a one-sided test.

17. The method for associating the precipitation forecast capability with the teleconnection effect based on coefficients of determination according to claim 16, wherein in the step S5, comparing the original sample data with the reference distribution of the three variances comprises: selecting a significance level, and determining a reference distribution threshold according to the selected significance level; if a value of the original sample data is greater than the reference distribution threshold of corresponding variances of the value of the original sample data, identifying that the value of the original sample data is significant, otherwise identifying that the value of the original sample data is non-significant; and then outputting a significance result as the association result of the precipitation forecast capability and the teleconnection effect.

18. The method for associating the precipitation forecast capability with the teleconnection effect based on coefficients of determination according to claim 17, further comprising following step: showing the significance result obtained by comparing the original sample data with the reference distribution of the three variances through a chart.

19. The method for associating the precipitation forecast capability with the teleconnection effect based on coefficients of determination according to claim 4, wherein the step of processing the three variances by means of bootstrapping comprises: disrupting the historical forecast precipitation data and the climate index sample sequence, repeating the steps S2 to S3 to obtain the corresponding three variances, and until a preset number of iterations is reached, obtaining the reference distribution of the three variances.

20. The method for associating the precipitation forecast capability with the teleconnection effect based on coefficients of determination according to claim 19, wherein in the step S5, the original sample data is compared with the reference distribution of the three variances by means of a one-sided test.
